(19) United States
(12) Patent Application Publication
(10) Pub. No.: US 2026/0124769 A1
(43) Pub. Date: May 7, 2026

(54) ROBOTIC ARM AND HUMANOID ROBOT

(71) Applicant: UBTECH ROBOTICS CORP LTD, Shenzhen (CN)

(72) Inventors: YANG LIU, Shenzhen (CN); Wenhua Fan, Shenzhen (CN); Xuchao Du, Shenzhen (CN)

(21) Appl. No.: 19/324,136

(22) Filed: Sep. 10, 2025

(30) Foreign Application Priority Data
Nov. 7, 2024 (CN) 202411585768.X

(51) Int. Cl. B25J 17/00

(52) U.S. Cl. CPC B25J 17/00

(57) ABSTRACT

A robotic arm and a humanoid robot that relate to a technical field of robots are provided. The robotic arm includes an upper arm assembly. The upper arm assembly includes an upper arm, a shoulder joint motor and an elbow joint motor. The upper arm includes an elbow joint end and a shoulder joint end. The shoulder joint motor includes a first housing and a first rotating shaft. The first housing is connected to the shoulder joint end of the upper arm. The elbow joint motor includes a second housing and a second rotating shaft. The second housing is connected to the elbow joint end of the upper arm. At least one of the first housing and the second housing is integrated with the upper arm. An integrated design of the upper arm meets lightweight and low-cost needs of the humanoid robot, and thus meets requirements of industrial applications.

### CROSS REFERENCE TO RELATED APPLICATIONS

The present disclosure claims foreign priority to Chinese Patent Application No. CN202411585768.X, titled “ROBOTIC ARM AND HUMANOID ROBOT”, filed on Nov. 7, 2024 in China National Intellectual Property Administration., and the entire contents of which are hereby incorporated by reference.

### TECHNICAL FIELD

The present disclosure relates to a technical field of robots, and in particular to a robotic arm and a humanoid robot.

### BACKGROUND

Robotic arms are representative and complex components in humanoid robot systems and are essential for humanoid robots to perform grasping tasks and facilitate human-robot interaction. However, the robotic arms are complex in structure and heavy, and manufacturing cost of the robotic arms is high. As humanoid robots enter industrial applications, there is an urgent need for lightweight and low-cost designs of the robotic arms.

### SUMMARY

In view of deficiencies in the prior art, a purpose of the present disclosure is to provide a robotic arm and a humanoid robot, in which an upper arm thereof is integrated to meet lightweight and low-cost requirements of the humanoid robot, thereby meeting requirements of industrial applications.

In a first aspect, embodiments of a first aspect of the present disclosure provide a robotic arm. The robotic arm comprises an upper arm assembly. The upper arm assembly comprises an upper arm, a shoulder joint motor and an elbow joint motor. The upper arm comprises an elbow joint end and a shoulder joint end. The shoulder joint motor comprises a first housing and a first rotating shaft. The first housing is connected to the shoulder joint end of the upper arm. The elbow joint motor comprises a second housing and a second rotating shaft. The second housing is connected to the elbow joint end of the upper arm. At least one of the first housing and the second housing is integrated with the upper arm.

In one embodiment, the second housing is integrated with the upper arm. An axis of the second rotating shaft is perpendicular to an axis of the first rotating shaft. The axis of the first rotating shaft coincides with or is parallel to an axis of the upper arm. A first groove is defined in the shoulder joint end of the upper arm. The shoulder joint motor is disposed in the first groove. The first groove comprises first groove walls. The first housing is connected to a corresponding one of the first groove walls.

In one embodiment, the first groove walls comprise two first groove walls. The first groove further comprises a first groove bottom wall. The two first groove walls are disposed opposite to each other. The first groove bottom wall abuts against the first housing. The two first groove walls abut against the first housing. Lightening holes are defined in the first groove bottom wall and/or the two first groove walls. At least one lightening groove is defined in the upper arm. The upper arm further comprises reinforcing ribs.

In one embodiment, the robotic arm further comprises a shoulder assembly. The shoulder assembly comprises a shoulder connecting end. A second groove is defined in the shoulder connecting end of the shoulder assembly. The second groove comprises a second groove wall. The upper arm assembly further comprises a first interconnecting piece. The first interconnecting piece is connected to the first rotating shaft. The first interconnecting piece passes through the second groove. The first interconnecting piece is connected to the second groove wall. The first interconnecting piece and the second groove are in transition fit or interference fit.

In one embodiment, the upper arm assembly further comprises a first zero-position marking piece. The first zero-position marking piece is connected to the first housing of the shoulder joint motor. The first zero-position marking piece comprises a first zero-position marking hole. The shoulder connecting end of the shoulder assembly defines a first mating hole. The first mating hole is located on a moving path of the first zero-position marking hole. When the first mating hole and the first zero-position marking hole are coaxial, the first rotating shaft is in a zero position.

In one embodiment, the robotic arm further comprises a forearm assembly. The upper arm assembly further comprises a second interconnecting piece. The second interconnecting piece is connected to the second rotating shaft. The second interconnecting piece comprises a first connecting end and a second connecting end disposed opposite to the first connecting end. The first connecting end of the second interconnecting piece is connected to the second rotating shaft. The second connecting end of the second interconnecting piece is rotatably connected to the second housing. The second connecting end and the first connecting end of the second interconnecting piece are rotatable coaxially.

In one embodiment, the upper arm assembly further comprises a third interconnecting piece. The third interconnecting piece comprises a plugging end. One end of the third interconnecting piece away from the plugging end is connected to the second connecting end of the second interconnecting piece. A third groove is defined in the second housing. A bearing is disposed in the third groove. The bearing and the third groove are in interference fit. The bearing and the second rotating shaft are coaxially disposed. A mounting hole is defined in the second connecting end of the second interconnecting piece. The plugging end of the third interconnecting piece passes through the mounting hole and an inner ring of the bearing. The plugging end of the third interconnecting piece is in interference fit with the inner ring of the bearing. A gap is defined between the second connecting end of the second interconnecting piece and the bearing.

In one embodiment, the shoulder assembly further comprises a limiting portion. The shoulder assembly is disposed on a torso assembly. The limiting portion is located on a moving path of the first zero-position marking piece. The limiting portion is configured to limit a rotation range of the shoulder joint motor, so that the torso assembly is located outside a motion range of the forearm assembly.

In one embodiment, the upper arm assembly further comprises a second zero-position marking piece. The second zero-position marking piece is connected to the second interconnecting piece, and the second zero-position marking piece comprises a second zero-position marking hole.

The second housing comprises a second mating hole. The second mating hole is located on a moving path of the second zero-position marking hole. When the second zero-position marking hole and the second mating hole are coaxially disposed, the second rotating shaft is in a zero position.

In a second aspect, the present disclosure provides a humanoid robot. The humanoid robot comprises the robotic arm described above.

In the robotic arm of the present disclosure, at least one of the first housing and the second housing forms an integrated structure with the upper arm. Such design not only reduces the number of components in the robotic arm, simplifies an assembly process and lowers costs, but also effectively reduces an overall weight of the robotic arm, thereby achieving weight reduction of the humanoid robot. Furthermore, the integrated structure, composed of at least one of the first housing and the second housing with the upper arm, improves the strength and stability of the robotic arm, ensuring that the robotic arm maintains excellent performance even in high-intensity operating environments.

The present disclosure further relates to the humanoid robot. Since the robotic arm has above-mentioned technical effects, the humanoid robot including the robotic arm has the same technical effects, which are not repeated herein.

In order to make the above objects, features, and properties of the present disclosure clear and understood, optional embodiments of the present disclosure are described in detail below with reference to the accompanying drawings.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a robotic arm according to one embodiment of the present disclosure.

FIG. 2 is an exploded schematic diagram of the robotic arm according to one embodiment of the present disclosure.

FIG. 3 is a schematic diagram of a second interconnecting piece assembled with a forearm assembly of the robotic arm according to one embodiment of the present disclosure.

FIG. 4 is a schematic diagram of an upper arm assembly of the robotic arm according to one embodiment of the present disclosure.

FIG. 5 is a schematic diagram of the upper arm assembly assembled with a shoulder assembly of the robotic arm according to one embodiment of the present disclosure.

FIG. 6 is an exploded schematic diagram of the upper arm assembly and the forearm assembly of the robotic arm according to one embodiment of the present disclosure.

FIG. 7 is a schematic diagram of a third interconnecting piece of the robotic arm according to one embodiment of the present disclosure.

FIG. 8 is a schematic diagram of a shoulder assembly of the robotic arm according to one embodiment of the present disclosure.

In the drawings:

100—shoulder assembly; 110—shoulder connecting end; 111—first mating hole; 112—limiter; 113—second groove; 200—upper arm assembly; 210—first zero-position marking piece; 211—first zero-position marking hole; 220—shoulder joint motor; 221—first rotating shaft; 222—first housing; 230—first groove; 231—first groove wall; 232—first groove bottom wall; 233—lightening holes; 240—upper arm; 241—shoulder joint end; 242—elbow joint end; 243—reinforcing rib; 250—elbow joint motor; 251—second rotating shaft; 252—second housing; 2521—second mating hole; 2522—third groove; 253—bearing; 2531—inner ring; 260—second interconnecting piece; 261—first connecting end; 262—second connecting end; 2621—mounting hole; 2622—second zero-position marking hole; 270—first interconnecting piece; 280—cable clamp; 290—third interconnecting piece; 291—first section; 292—second section; 293—third section.

### DETAILED DESCRIPTION

Embodiments of the present disclosure are described in detail below. Examples of the embodiments are shown in the accompanying drawings, in which the same or similar reference numerals indicate the same or similar elements or elements with the same or similar functions. The embodiments described below with reference to the drawings are exemplary, and are intended to explain the present disclosure, but should not be regarded as a limitation to the present disclosure.

It should be noted that when an element is referred to as being “fixed to” another element, it may be directly fixed to another element or indirectly fixed to another element through intervening elements. When the element is considered to be “connected” to another element, it may be directly connected to another element or intervening elements may be present at the same time. When the element is considered to be “directly connected” to another element, there is no intervening element. The terms “vertical”, “horizontal”, “left”, “right”, and the like, as used herein, are for illustrative purposes only.

It should be noted in the description of the present disclosure that, unless otherwise regulated and defined, terms such as “installation,” “bonded,” and “connection” shall be understood in a broad sense, and for example, may refer to fixed connection or detachable connection or integral connection; may refer to mechanical connection or electrical connection; and may refer to direct connection or indirect connection through an intermediate medium or inner communication of two elements. For those of ordinary skill in the art, the meanings of the above terms in the present disclosure may be understood according to concrete conditions.

In addition, terms such as “first” and “second” are only used for the purpose of description, rather than being understood to indicate or imply relative importance or hint the number of indicated technical features. Thus, the feature limited by “first” and “second” can explicitly or implicitly comprise one or more features. In the description of the present disclosure, the meaning of “a plurality of” is two or more unless otherwise specified.

Unless otherwise defined, all technical and scientific terms used herein have the same meaning as commonly understood by those skilled in the art of the present disclosure. The terms used in the description of the present disclosure herein are only for the purpose of describing specific embodiments, and are not intended to limit the present disclosure. The term “and/or” used in the present disclosure comprises any and all combinations of one or more of the associated listed items.

In the related art, with advancement of science and technology, research and application fields of robots are constantly expanding. Particularly, research and applications of humanoid robots have received particular attention and are one of the most active research hotspots in a technical field of robotics.

Robotic arms are representative and complex components in humanoid robot systems and are essential for humanoid robots to perform grasping tasks and facilitate human-robot interaction. However, the robotic arms are complex in structure and heavy, and manufacturing cost of the robotic arms is high. As humanoid robots enter industrial applications, there is an urgent need for lightweight and low-cost designs of the robotic arms.

To solve above technical problems, one embodiment of the present disclosure provides a robotic arm. The robotic arm comprises an upper arm assembly 200. The upper arm assembly 200 comprises an upper arm 240, a shoulder joint motor 220 and an elbow joint motor 250. The upper arm 240 comprises an elbow joint end 242 and a shoulder joint end 241. The shoulder joint motor 220 comprises a first housing 222 and a first rotating shaft 221. The first housing 222 is connected to the shoulder joint end 241 of the upper arm 240. The elbow joint motor 250 comprises a second housing 252 and a second rotating shaft 251. An axis of the second rotating shaft 251 intersects with an axis of the first rotating shaft 221. The second housing 252 is connected to the elbow joint end 242 of the upper arm 240. At least one of the first housing 222 and the second housing 252 is integrated with the upper arm 240.

In the embodiment, the upper arm 240 serves as a main structural component of the robotic arm and has two key endpoints, which are respectively the elbow joint end 242 and the shoulder joint end 241. The elbow joint end 242 and the shoulder joint end 241 are respectively configured to connect to the elbow joint motor 250 and the shoulder joint motor 220, so that the robotic arm is enabled to move freely in multiple dimensions.

The shoulder joint motor 220 is configured to drive the robotic arm to rotate around the shoulder. The shoulder joint motor 220 comprises the first housing 222 and the first rotating shaft 221. The first housing 222 is connected to the shoulder joint end 241 of the upper arm 240, while the first rotating shaft 221 is configured to transmit power to rotate the upper arm 240 around the shoulder. For instance, the shoulder joint motor 220 is a steering engine. Of course, the shoulder joint motor 220 may be a servo motor, a stepper motor, or other similar device, which is not limited thereto.

The elbow joint motor 250 is configured to drive the robotic arm to perform bending and extension motions at the elbow joint end 242 of the upper arm 240. The elbow joint motor 250 comprises the second housing 252 and the second rotating shaft 251. The second housing 252 is connected to the elbow joint end 242 of the upper arm 240, and the axis of the second rotating shaft 251 intersects with the axis of the first rotating shaft 221. In this way, motion flexibility and a motion range of the robotic arm are improved in space. For instance, in the embodiment, the axis of the second rotating shaft 251 is perpendicular to the axis of the first rotating shaft 221. Of course, in other embodiments, an included angle between the axis of the second rotating shaft 251 and the axis of the first rotating shaft 221 is 30°, 40°, 50°, 60°, or 70°, etc., which is not specifically limited herein and may be set according to a specific usage scenario. For instance, the elbow joint motor 250 is a steering engine. Of course, the elbow joint motor 250 may be a servo motor, a stepper motor, etc.

It should be noted that at least one of the first housing 222 and the second housing 252 forms an integrated structure with the upper arm 240. Such design not only reduces the number of components in the robotic arm, simplifies an assembly process and lowers costs, but also effectively reduces an overall weight of the robotic arm, thereby achieving weight reduction of the humanoid robot. Furthermore, the integrated structure, composed of at least one of the first housing 222 and the second housing 252 with the upper arm 240, improves the strength and stability of the robotic arm, ensuring that the robotic arm maintains excellent performance even in high-intensity operating environments.

In some embodiments, the second housing 252 is integrated with the upper arm 240. Of course, in other embodiments, the first housing 252 is integrated with the upper arm 240. Alternatively, the second housing 252, the first housing 222, and the upper arm 240 are integrally formed.

As shown in FIG. 4, when the second housing 252 is integrated with the upper arm 240, the axis of the second rotating shaft 251 is perpendicular to the axis of the first rotating shaft, and the axis of the first rotating shaft 221 coincides with or is parallel to an axis of the upper arm 240. A first groove 230 is defined in the shoulder joint end 241 of the upper arm 240. The shoulder joint motor 220 is disposed in the first groove 230. The first groove 230 comprises first groove walls 231. The first housing 222 is connected to a corresponding one of the first groove walls 231.

In the embodiment, such design not only improves a structural compactness of the robotic arm, but also ensures a stable connection between the shoulder joint motor 220 and the upper arm 240, thereby improving the overall stability and reliability of the robotic arm.

For instance, the first groove 230 of the shoulder joint end 241 of the upper arm 240 is in a U shape or a C shape, which provides sufficient space to accommodate the shoulder joint motor 220. The first groove walls 231 comprise two first groove walls 231 disposed on two sides of the first groove 230. The two first groove walls 231 are connected to the first housing 222 to ensure that the shoulder joint motor 220 is firmly fixed to the upper arm 240. Such design not only simplifies an assembly process, but also reduces the number of external connectors, thereby reducing the weight and cost of the robotic arm.

Furthermore, since the shoulder joint motor 220 is directly connected to the upper arm 240, energy loss is reduced during power transmission, thereby improving working efficiency of the robotic arm.

Obviously, through above-described technical solutions, the present disclosure provides the robotic arm that is compact, lightweight, low-cost, and reliable, significantly enhancing the applicability and economic efficiency of the humanoid robot in industrial applications.

Of course, in other embodiments, the number of the first groove walls 231 may be three, four, etc., which is not limited thereto.

In some embodiments, as shown in FIG. 4, the first groove walls 231 comprise two first groove walls 231. The first groove 230 further comprises a first groove bottom wall 232. The two first groove walls 231 are disposed opposite to each other. The first groove bottom wall 232 abuts against the first housing 222. The two first groove walls 231 abut against the first housing 222.

In the embodiments, the shoulder joint end 241 of the upper arm 240 comprises the first groove 230, and the shoulder joint motor 220 is accommodated in the first groove 230. Specifically, the first groove 230 comprises the first groove bottom wall 232 and the two first groove walls 231 disposed opposite each other. The first groove bottom wall 232 abuts against the first housing 222, while the two first groove walls 231 also abut against the first housing 222. In this way, a secure connection between the shoulder joint motor 220 and the upper arm 240 is ensured while achieving a lightweight design of the robotic arm by reducing the number of the external connectors.

The first groove 230 of the shoulder joint end 241 of the upper arm 240 may be a U-shaped groove, with the first groove bottom wall 232 located at a center thereof and the two first groove walls 231 on two sides thereof. The first groove 230 effectively accommodates the shoulder joint motor 220. The first groove bottom wall 232 and the two first groove walls 231 abut against the first housing 222 to stably position the shoulder joint motor in the upper arm 240. Further, no additional connectors are used, which reduces the overall weight and the manufacturing cost of the robotic arm.

The first groove 230 further improves the reliability and durability of the robotic arm. Because the shoulder joint motor 220 is directly embedded in the upper arm 240, an impact of external factors on the shoulder joint motor 220 is reduced, so that the robotic arm is enabled to maintain high efficiency and accuracy during long-term continuous operation. Furthermore, since the external connectors are reduced, a possibility of failure of the robotic arm during operation is reduced.

Optionally, the two first groove walls 231 are connected to the first housing 222 of the shoulder joint motor 220 by bolts or screws. Since a bottom portion of the first housing 222 contacts the first groove bottom wall 232, there is no need to fix the bottom portion of the first housing 222.

For ease of understanding, an assembling method is provided as follows. Specifically, the first housing 222 of the shoulder joint motor 220 is placed in the first groove 230 of the shoulder joint end 241 of the upper arm 240. It should be noted that the first groove bottom 232 must abut against the first housing 222, and the two first groove walls 231 must abut against the first housing 222 to form a stable connection between the shoulder joint motor 220 and the first groove 230. The first housing 222 of the shoulder joint motor 220 is placed in the first groove 230 of the shoulder joint end 241 of the upper arm. A shape of the first groove 230 is designed to fit closely to an outer contour of the first housing 222 to ensure that the shoulder joint motor 220 is securely mounted. The first groove bottom wall 232 contacts the bottom portion of the first housing 222 and the first groove bottom wall 232 form a stable support surface for the first housing 222. The two first groove walls 231 contact two sides of the first housing 222 to provide stable side support for the first housing.

In some embodiments, as shown in FIG. 4, lightening holes 233 are defined in the first groove bottom wall 232 and/or the two first groove walls 231. A lightening groove is defined in the upper arm 240. The upper arm 240 further comprises reinforcing ribs 243.

In the embodiments, in order to further reduce the weight of the robotic arm, the first groove bottom wall 232 and/or the two first groove walls 231 define lightening holes 233. Optionally, in the embodiments, the lightening holes 233 are defined in the first groove bottom wall 232 and the two first groove walls 231. Of course, in other embodiments, the lightening holes 233 are only defined in the first groove bottom wall 232. Alternatively, the lightening holes 233 are only defined in the two first groove walls 231. It should be noted that the lightening holes 233 increase a contact area between the shoulder joint motor 220 and air, which enhances heat dissipation performance of the shoulder joint motor 220. Obviously, the lightening holes 233 defined in the first groove bottom wall 232 and/or the two first groove walls 231 do not affect a structural strength of the robotic arm.

Specifically, there are many lightening holes, that is, the lightening holes are spaced from each other to ensure the structural strength of the first groove bottom wall 232 and the two first groove walls 231. Of course, a shape of each of the lightening holes 233 may be circular, square, oval, triangular, special-shaped, etc., which is not limited thereto.

In addition, the upper arm 240 comprises the lightening groove, and to ensure the structural strength of the upper arm 240, the reinforced ribs are provided. It should be noted that a groove bottom wall of the lightening groove, combined with the reinforcing ribs 243, ensures the structural strength of the upper arm 240 while reducing weight.

In other words, while the lightening groove is designed to reduce material usage, a forces acting on the robotic arm must be considered to ensure that the overall weight of the robotic arm is reduced while ensuring the structural strength. Furthermore, the reinforcing ribs 243 compensate for a reduced structural strength caused by the lightening groove, which ensure that the robotic arm maintains good performance even in high-intensity operating environments.

For example, the upper arm 240 is configured as a plate structure, and lightening grooves are disposed on two sides of the upper arm 240. Alternatively, in other embodiments, only one lightening groove is defined in one side of the upper arm 240.

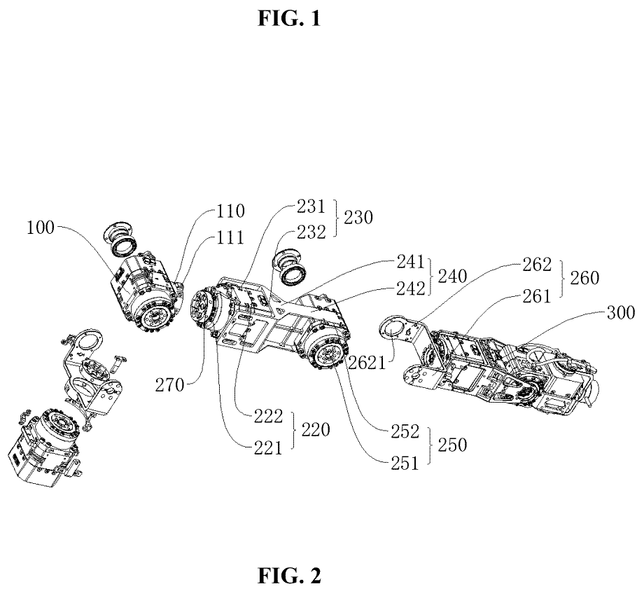

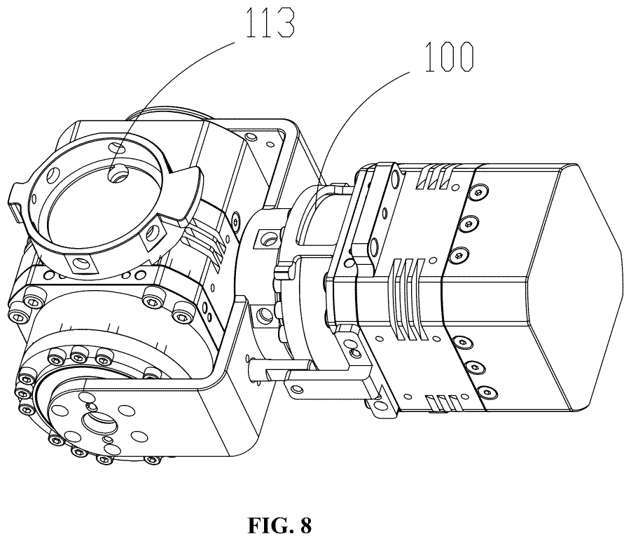

In some embodiments, as shown in FIGS. 1, 2, 4, 5 and 8, the robotic arm further comprises a shoulder assembly 100. The shoulder assembly 100 comprises a shoulder connecting end 110. A second groove 113 is defined in the shoulder connecting end 110 of the shoulder assembly 100. The second groove 113 comprises a second groove wall. The upper arm assembly 200 further comprises a first interconnecting piece 270. The first interconnecting piece 270 is connected to the first rotating shaft 221. The first interconnecting piece 270 passes through the second groove 113. The first interconnecting piece 270 is connected to the second groove wall. The first interconnecting piece 270 and the second groove 113 are in transition fit or interference fit.

In the embodiments, to ensure a secure connection between the shoulder assembly 100 and the upper arm assembly 200, the shoulder connecting end 110 of the shoulder assembly 100 is connected to the first interconnecting piece 270 of the upper arm assembly 200. The first interconnecting piece 270 passes through the second groove 113 of the shoulder connecting end 110 of the shoulder assembly 100, and the transition fit or interference fit is ensured between the first interconnecting piece 270 and the second groove wall to achieve secure positioning between the shoulder assembly 100 and the upper arm assembly 200.

Furthermore, the second groove wall of the second groove 113 and the first interconnecting piece 270 are connected by a screw or a first bolt. For instance, the first interconnecting piece 270 is cylindrical, a lower end of the first interconnecting piece 270 is connected to the first rotating shaft 221, and an upper end of the first interconnecting piece 270 passes through the second groove 113. The second groove 113 is configured as a circular hole. The second groove 113 and the first interconnecting piece 270 are in the transition fit or interference fit, causing the second groove wall of the second groove 113 and the first interconnecting piece 270 to abut against each other, thereby improving the connection stability therebetween. The second groove wall defines a through hole, the first interconnecting piece 270 comprises a threaded hole, the screw passes through the through hole and is screwed into the threaded hole.

In addition, such design not only improves the rigidity of the robotic arm, but also simplifies the assembly process and reduces the manufacturing costs.

In some embodiments, as shown in FIG. 9, the upper arm assembly 200 further comprises a first zero-position marking piece 210. The first zero-position marking piece 210 is connected to the first housing 222 of the shoulder joint motor 220. The first zero-position marking piece 210 comprises a first zero-position marking hole 211. The shoulder connecting end 110 of the shoulder assembly 100 defines a first mating hole 111. The first mating hole 111 is located on a moving path of the first zero-position marking hole 211. When the first zero-position marking hole 211 and the first zero-position marking hole 211 are coaxial, the first rotating shaft 221 is in a zero position (i.e., an initial position).

In the embodiments, a position of the first zero-position marking hole 211 is adjustable to facilitate calibration and maintenance of the robotic arm. When the first zero-position marking hole 211 is coaxially aligned with the first mating hole 111, the first rotating shaft 221 is in the zero position, thereby facilitating initialization and position calibration of the robotic arm. Therefore, it is ensured that the robotic arm is accurately reset during use, thereby improving the reliability and accuracy of the humanoid robot. Obviously, it is necessary to consider connecting the first zero-position marking piece 210 to the first housing 222 of the shoulder joint motor 220 and ensuring that the first zero-position marking hole 211 on the first zero-position marking piece 210 is coaxially aligned with the first mating hole 111 on the shoulder connecting end 110 of the shoulder assembly 100.

In other words, to reset the shoulder joint motor 220 to the zero position, it only needs to simply align the first zero-position marking hole 211 on the first zero-position marking piece 210 with the first mating hole 111 on one side of the shoulder connecting end 110 of the shoulder assembly 100. A first pin having an equal diameter as that of the first zero-position marking hole 211 and the first mating hole 111 is then inserted through the first zero-position marking hole 211 and the first mating hole 111 to reset the shoulder joint motor 220 to the zero position.

For instance, a cable clamp 280 configured to secure a cable is disposed on the first zero-position marking piece 210. The cable clamp 280 may be a C-shaped cable clamp.

In some embodiments, as shown in FIGS. 2, 3, and 6, the robotic arm further comprises a forearm assembly. The upper arm assembly 200 further comprises a second interconnecting piece 260. The second interconnecting piece 260 is connected to the second rotating shaft 251. The second interconnecting piece 260 comprises a first connecting end 261 and a second connecting end 262 disposed opposite to the first connecting end 261. The first connecting end 261 of the second interconnecting piece 260 is connected to the second rotating shaft 251. The second connecting end 262 of the second interconnecting piece 260 is rotatably connected to the second housing 252. The second connecting end 262 and the first connecting end 261 of the second interconnecting piece 260 are rotatable coaxially.

In the embodiments, in the forearm assembly, the first connecting end 261 of the second interconnecting piece 260 is connected to the second rotating shaft 251, the second connecting end 262 is rotatably connected to the second housing 252, and the second connecting end 262 and the first connecting end 261 of the second interconnecting piece 260 rotate coaxially. Therefore, the forearm assembly is enabled to be stably connected to the upper arm assembly 200, and the forearm assembly is enabled to move flexibly in multiple dimensions. That is, since the first connecting end 261 of the second interconnecting piece 260 is connected to the second rotating shaft 251, when the second rotating shaft 251 of the elbow joint motor 250 rotates, the second rotating shaft 251 drives the forearm assembly to straighten or bend. Furthermore, the second connecting end 262 of the second interconnecting piece 260 is rotatably connected to the second housing 252, which provides auxiliary support for the forearm assembly to a tail portion of the elbow joint motor 250, thereby enhancing the connection stability and connection strength between the forearm assembly and the upper arm assembly 200.

Obviously, the first connecting end 261 and the second connecting end 262 of the second interconnecting piece are U-shaped structures, which ensure a stable connection between the forearm assembly and the upper arm assembly 200 while reducing overall weight of the robotic arm.

It should be noted that a pivoting connection between the second connecting end 262 of the second interconnecting piece and the second housing 252 is predetermined so that the first connecting end 261 and the second connecting end 262 of the second interconnecting piece are capable of rotating around the axis of the second rotating shaft.

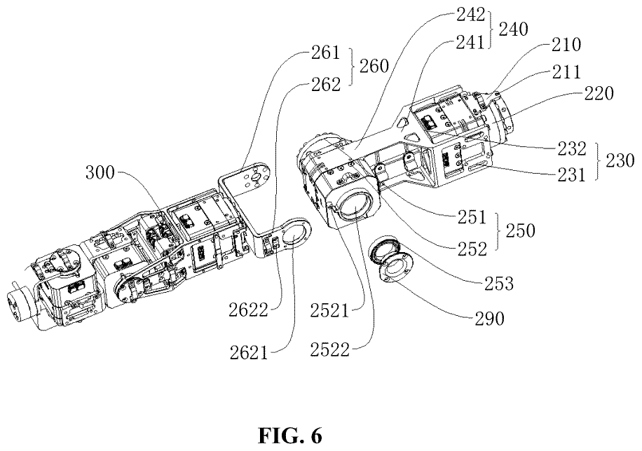

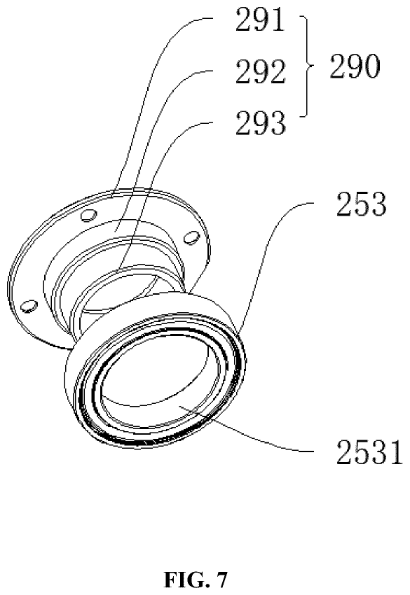

In some embodiments, as shown in FIGS. 6-7, the upper arm assembly 200 further comprises a third interconnecting piece 290. The third interconnecting piece 290 comprises a plugging end. One end of the third interconnecting piece away from the plugging end is connected to the second connecting end 262 of the second interconnecting piece 260. A third groove 2522 is defined in the second housing 252, a bearing 253 is disposed in the third groove 2522. The bearing 253 and the third groove 2522 are in interference fit. The bearing 253 and the second rotating shaft 251 are coaxially disposed. A mounting hole 2621 is defined in the second connecting end 262 of the second interconnecting piece 260. The plugging end of the third interconnecting piece 290 passes through the mounting hole 2621 and an inner ring 2531 of the bearing 253. The plugging end of the third interconnecting piece is in interference fit with the inner ring 2531 of the bearing 253. A gap is defined between the second connecting end 262 of the second interconnecting piece 260 and the bearing 253.

In the embodiments, the upper arm assembly 200 is not limited to a basic arm structure, but also integrates the third interconnecting piece 290. The third interconnecting piece 290 plays a key role in the flexibility and stability of the robotic arm. Specifically, the third interconnecting piece 290 has the plugging end for assembly, and one end thereof away from the plugging end thereof is connected to the second connecting end 262 of the second interconnecting piece 260 in the upper arm assembly 200. In order to ensure that a connection mechanism operates efficiently, the third groove 2522 is specially defined in the second housing 252 of the upper arm assembly 200. The bearing 253 is positioned in the third groove 2522. The bearing 253 and the groove are in the interference fit, which means that the bearing 253 is tightly fixed in the third groove, thereby reducing loosening or displacement during motion, ensuring the stability of the robotic arm during operation, eliminating a need for fasteners such as bolts for fixing, and reducing the overall weight and costs.

Furthermore, the second connecting end 262 of the second interconnecting piece 260 located on the upper arm assembly 200 comprises the mounting hole 2621. During assembly, the plugging end of the third interconnecting piece 290 passes through the mounting hole 2621 and extends into the inner ring 2531 of the bearing 253. The plugging end of the third interconnecting piece 290 fits tightly with the inner ring 2531 by interference fit, which ensures a secure connection between the first interconnecting piece 270 and the bearing 253. Therefore, the robotic arm maintains good performance even when subjected to high loads or performing rapid motions. It is worth noting that the gap is reserved between the second connecting end 262 of the second interconnecting piece 260 and the bearing 253, which provides a certain degree of motion freedom. The gap is able to offset minor deviations or vibrations generated during a motion of the robotic arm, thereby enhancing the overall stability and durability of the humanoid robot. Furthermore, the gap prevents the second connecting end 262 of the second interconnecting piece 260 from contacting the second housing 252 and the bearing 253, thereby avoiding jamming.

For instance, in the embodiment, the one end of the third interconnecting piece 290 away from the plugging end is connected to the second connecting end 262 of the second interconnecting piece 260 through a second bolt. Specifically, the third interconnecting piece 290 comprises a first section 291, a second section 292 and a third section 293. The second section 292 connects the first section 291 and the third section 293. Outer diameters of the first section 291, the second section 292, and the third section 293 reduce in sequence. The mounting hole 2621 and the second section 292 are in the interference fit. An outer diameter of the second section 292 is greater than an inner diameter of the inner ring 2531 but is less than an outer diameter of the inner ring 2531. A shaft shoulder between the second section 292 and the third section 293 abuts against an end portion of the inner ring 2531. An outer diameter of the first section 291 is greater than a diameter of the mounting hole 2621. The second connecting end 262 of the second interconnecting piece is connected to the first section 291 through the second bolt and an axial length of the second section 292 is greater than a thickness of the second connecting end 262 of the second interconnecting piece 260.

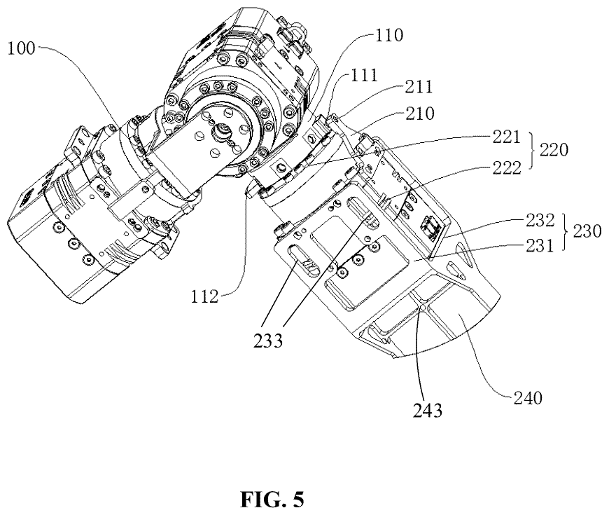

In some embodiments, as shown in FIG. 5, the shoulder assembly 100 further comprises a limiting portion 112. The shoulder assembly 100 is disposed on a torso assembly. The limiting portion 112 is located on a moving path of the first zero-position marking piece 210. The limiting portion 112 is configured to limit a rotation range of the shoulder joint motor 220, so that the torso assembly is located outside a motion range of the forearm assembly.

In the embodiments, to limit the rotation range of the shoulder joint motor 220 and prevent damage to the robotic arm due to excessive rotation, the shoulder assembly 100 further comprises the limiting portion 112. The limiting portion 112 is located on the moving path of the first zero-position marking piece 210. The limiting portion 112 limits the rotation range of the shoulder joint motor 220, ensuring that the robotic arm operates within a safe range, even if the torso assembly is outside motion range of the forearm assembly.

For instance, the limiting portion 112 is positioned on one side of the shoulder connecting end 110 of the shoulder assembly 100 close to the torso assembly of the humanoid robot to prevent the forearm assembly from rotating and colliding with the torso assembly.

The limiting portion 112 is not specifically limited thereto. In the embodiment, the limiting portion 112 is a protrusion disposed on the one side of the shoulder connecting end 110 of the shoulder assembly 100. Of course, in other embodiments, the limiting portion 112 is a block fixed to the one side of the shoulder connecting end 110 of the shoulder assembly 100.

More specifically, the protrusion may extend along a circumference of the shoulder connecting end 110 of the shoulder assembly 10 or along the moving path of the first zero-position marking piece 210. By configuring an extension length of the protrusion, the rotation range of the shoulder joint motor 220 is limited. Of course, the limiting portion may be two protrusions positioned along the moving path of the first zero-position marking piece 210, and a distance between the two protrusions is predetermined to achieve the same effect.

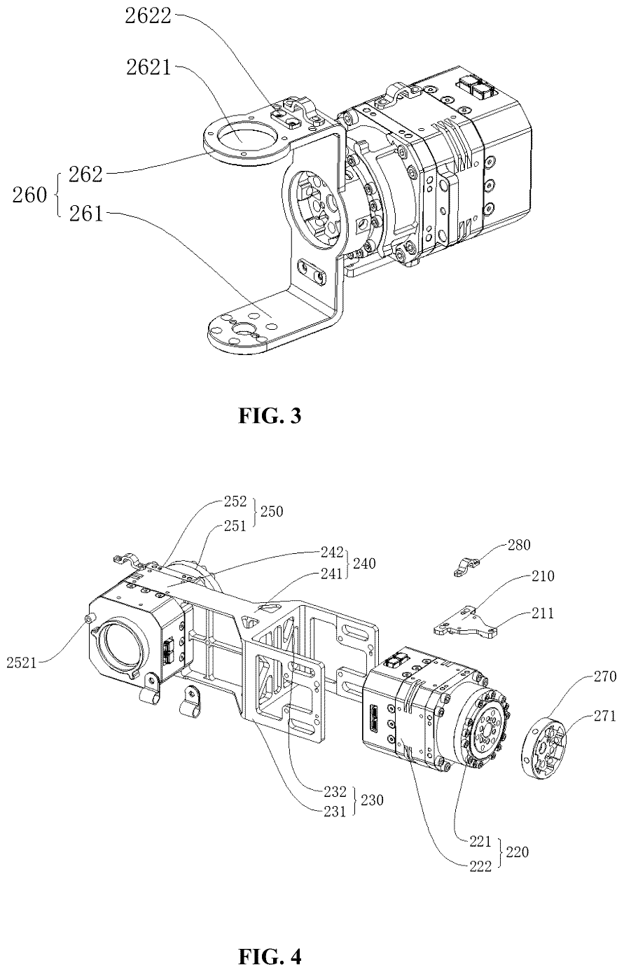

In some embodiments, as shown in FIGS. 3 and 6, the upper arm assembly 200 further comprises a second zero-position marking piece. The second zero-position marking piece is connected to the second interconnecting piece 260, and the second zero-position marking piece comprises a second zero-position marking hole 2622. The second housing 252 comprises a second mating hole 2521. The second mating hole 2521 is located on a moving path of the second zero-position marking hole 2622. When the second zero-position marking hole 2622 and the second mating hole 2521 are coaxially disposed, the second rotating shaft 251 is in a zero position.

In the embodiments, the upper arm assembly 200 further comprises the second zero-position marking piece in addition to basic components. The main function of this second zero-position marking piece is to establish a connection with the second interconnecting piece 260, thereby providing a precise position reference for the robotic arm. The second zero-position marking piece is provided with a second zero-position marking hole 2622, which plays a crucial role in a positioning process of the robot arm. In order to achieve precise positioning, the second mating hole 2521 is specially defined in the second housing 252, and a position of the second mating hole 2521 is disposed on an expected moving path of the second zero-position marking hole 2622. In this way, the second zero-position marking hole 2622 and the second mating hole 2521 are ensured to be aligned under certain conditions.

Specifically, when the second mating hole 2521 and the second zero-position marking hole 2622 are coaxially disposed (that is, the second mating hole 2521 and the second zero-position marking hole 2622 are completely aligned and overlapped), a second pin passes through the second mating hole 2521 and the second zero-position marking hole 2622 to make the second rotating shaft 251 reach the zero position. The zero position of the second rotating shaft 251 is crucial for the calibration of the robotic arm, and the zero position of the second rotating shaft 251 defines a reference position of the robotic arm, and all subsequent actions of the robotic arm are calculated and adjusted based on the zero position.

For instance, the second zero-position marking piece is disposed on an outer side of the second connecting end 262 of the second interconnecting piece 260. The second zero-position marking piece defined the second zero-position marking hole 2622. The second zero-position marking hole 2622 penetrates through the second zero-position marking piece and the second connecting end 262 of the second interconnecting piece 260, and the second zero-position marking hole 2521 is disposed at the one end of the elbow joint motor 250 away from the second rotating shaft 251.

For instance, suppose that in an industrial automation environment, the robotic arm needs to perform a series of complex tasks, such as assembling electronic components. Before starting any operation, the robotic arm needs to be accurately calibrated to the zero position. An operator is able to move the second zero-position marking hole 2622 and align it with the second mating hole 2521 through manual or automatic control. Once the second mating hole 2521 and the second zero-position marking hole 2622 are aligned, it means that the second rotation shaft 251 is adjusted to be in the zero position. At this time, the humanoid robot records the zero position as the initial position and executes subsequent action instructions based on the zero position.

Obviously, the design not only improves the working accuracy of the robotic arm, but also simplifies an operation process. During daily maintenance and use, the operator is able to quickly reset the robotic arm to the zero position, which is very important for ensuring consistency and quality control on a production line.

One embodiment of the present disclosure further provides a humanoid robot. The humanoid robot comprises the robotic arm described above.

Obviously, the present disclosure is not only limited to a single robotic arm, but also proposes a completely new integrated solution, namely the humanoid robot. The humanoid robot integrates the technology of robotic arm described in various embodiments described above and aims to provide the user with a more intelligent, flexible and efficient automation solution. One of design goals of the humanoid robot is to imitate human body structure and motility abilities to achieve more natural human-robot interaction and a wide range of application scenarios. As an important part of humanoid robot, the robotic arm assumes key responsibilities of performing various tasks, such as grabbing objects and performing fine operations.

In all embodiments shown and described herein, any specific value should be interpreted as merely exemplary and not as a limitation. Therefore, other examples of the exemplary embodiments may have different values.

It should be noted that similar reference numerals and letters indicate similar items in the following drawings. Therefore, once an item is defined in one drawing, it does not need to be further defined and explained in the other drawings.

The above-mentioned embodiments only express several embodiments of the present disclosure, and the description thereof is relatively specific and detailed, but should not be construed as a limitation on the scope of the present disclosure. It should be noted that for those of ordinary skill in the art, several modifications and improvements can be made without departing from the concept of the present disclosure, and these modifications and improvements should fall within the protection scope of the present disclosure.

What is claimed is:

1. A robotic arm, comprising:
an upper arm assembly;
wherein the upper arm assembly comprises an upper arm, a shoulder joint motor, and an elbow joint motor;
wherein the upper arm comprises an elbow joint end and a shoulder joint end, the shoulder joint motor comprises a first housing and a first rotating shaft, the first housing is connected to the shoulder joint end of the upper arm, the elbow joint motor comprises a second housing and a second rotating shaft, and the second housing is connected to the elbow joint end of the upper arm;
wherein at least one of the first housing and the second housing is integrated with the upper arm.

2. The robotic arm according to claim 1, wherein the second housing is integrated with the upper arm, an axis of the second rotating shaft is perpendicular to an axis of the first rotating shaft, the axis of the first rotating shaft coincides with or is parallel to an axis of the upper arm, a first groove is defined in the shoulder joint end of the upper arm, the shoulder joint motor is disposed in the first groove, the first groove comprises first groove walls, and the first housing is connected to a corresponding one of the first groove walls.

3. The robotic arm according to claim 2, wherein the first groove walls comprise two first groove walls, the first groove further comprises a first groove bottom wall, the two first groove walls are disposed opposite to each other, the first groove bottom wall abuts against the first housing, and the two first groove walls abut against the first housing;
wherein lightening holes are defined in the first groove bottom wall and/or the two first groove walls, at least one lightening groove is defined in the upper arm, and the upper arm further comprises reinforcing ribs.

4. The robotic arm according to claim 3, wherein the robotic arm further comprises a shoulder assembly, the shoulder assembly comprises a shoulder connecting end, a second groove is defined in the shoulder connecting end of the shoulder assembly, and the second groove comprises a second groove wall;
wherein the upper arm assembly further comprises a first interconnecting piece, the first interconnecting piece is connected to the first rotating shaft, the first interconnecting piece passes through the second groove, the first interconnecting piece is connected to the second groove wall, and the first interconnecting piece and the second groove are in transition fit or interference fit.

5. The robotic arm according to claim 4, wherein the upper arm assembly further comprises a first zero-position marking piece, the first zero-position marking piece is connected to the first housing of the shoulder joint motor, and the first zero-position marking piece comprises a first zero-position marking hole;
wherein the shoulder connecting end of the shoulder assembly defines a first mating hole, the first mating hole is located on a moving path of the first zero-position marking hole, and when the first mating hole and the first zero-position marking hole are coaxial, the first rotating shaft is in a zero position.

6. The robotic arm according to claim 5, wherein the robotic arm further comprises a forearm assembly, the upper arm assembly further comprises a second interconnecting piece, and the second interconnecting piece is connected to the second rotating shaft;
wherein the second interconnecting piece comprises a first connecting end and a second connecting end disposed opposite to the first connecting end, the first connecting end of the second interconnecting piece is connected to the second rotating shaft, the second connecting end of the second interconnecting piece is rotatably connected to the second housing, and the second connecting end and the first connecting end of the second interconnecting piece are rotatable coaxially.

7. The robotic arm according to claim 6, wherein the upper arm assembly further comprises a third interconnecting piece, the third interconnecting piece comprises a plugging end, and one end of the third interconnecting piece away from the plugging end is connected to the second connecting end of the second interconnecting piece;
wherein a third groove is defined in the second housing, a bearing is disposed in the third groove, the bearing and the third groove are in interference fit, the bearing and the second rotating shaft are coaxially disposed, a mounting hole is defined in the second connecting end of the second interconnecting piece, the plugging end of the third interconnecting piece passes through the mounting hole and an inner ring of the bearing, the plugging end of the third interconnecting piece is in interference fit with the inner ring of the bearing, and a gap is defined between the second connecting end of the second interconnecting piece and the bearing.

8. The robotic arm according to claim 6, wherein the shoulder assembly further comprises a limiting portion, the shoulder assembly is configured to be disposed on an external torso assembly, the limiting portion is located on a moving path of the first zero-position marking piece, and the limiting portion is configured to limit a rotation range of the shoulder joint motor, so that the external torso assembly is located outside a motion range of the forearm assembly.

9. The robotic arm according to claim 6, wherein the upper arm assembly further comprises a second zero-position marking piece, the second zero-position marking piece is connected to the second interconnecting piece, and the second zero-position marking piece comprises a second zero-position marking hole;
wherein the second housing comprises a second mating hole, the second mating hole is located on a moving path of the second zero-position marking hole, and when the second zero-position marking hole and the second mating hole are coaxially disposed, the second rotating shaft is in a zero position.

10. The robotic arm according to claim 7, wherein the third interconnecting piece comprises a first section, a second section, and a third section, wherein the second section connects the first section and the third section, and outer diameters of the first section, the second section, and the third section reduce in sequence;
wherein the mounting hole and the second section are in interference fit, an outer diameter of the second section is greater than an inner diameter of the inner ring and is less than an outer diameter of the inner ring, an outer diameter of the first section is greater than a diameter of the mounting hole, and an axial length of the second section is greater than a thickness of the second connecting end of the second interconnecting piece.

11. A humanoid robot, comprising: the robotic arm according to claim 1.
